(19) United States
(12) Patent Application Publication
(10) Pub. No.: US 2013/0170222 A1
(43) Pub. Date: Jul. 4, 2013

(54) LIGHT EMITTING DIODE LAMP HAVING VARIABLE LIGHT FIELD

(71) Applicants: HOU-TE LIN, Hukou (TW); CHAO-HSIUNG CHANG, Hukou (TW)

(72) Inventors: HOU-TE LIN, Hukou (TW); CHAO-HSIUNG CHANG, Hukou (TW)

(73) Assignee: ADVANCED OPTOELECTRONIC TECHNOLOGY, INC., Hsinchu Hsien (TW)

(21) Appl. No.: 13/600,143

(22) Filed: Aug. 30, 2012

(30) Foreign Application Priority Data
Dec. 29, 2011 (CN) 201110450656.X

(51) Int. Cl. F21V 13/04; F21V 5/04

(52) U.S. Cl. 362/309; 362/308; 362/311.02

(57) ABSTRACT

A light emitting diode lamp includes a lamp body, a light emitting diode arranged on the lamp body, and a lamp cover to cover the light emitting diode. The lamp cover includes a lens in front of the light emitting diode to modulate the light from the light emitting diode. The light emitting diode lamp further includes a driver and an adjusting device. The driver is formed between the lamp body and a lamp cover. The adjusting device controls the driver to adjust a distance between the lens and the light emitting diode, whereby a light filed of the light from the light emitting diode is adjustable.

### BACKGROUND

1. Technical Field

The disclosure generally relates to a lamp, and particularly relates to a light emitting diode lamp with adjustable lighting distribution.

2. Description of Related Art

In recent years, due to excellent light quality and high luminous efficiency, light emitting diodes (LEDs) have increasingly been used as substitutes for incandescent bulbs, compact fluorescent lamps and fluorescent tubes as light sources of illumination devices.

Generally, when an LED is used as a light source, a lens is needed to generate a predetermined lighting distribution for the LED. However, the lens is fixed to the LED and can not be movable. The lighting distribution of the LED can not be adjusted to meet the different requirements of the outer environment.

What is needed, therefore, is an LED lamp to overcome the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a cross-sectional view showing an LED lamp in accordance with a first embodiment of the present disclosure.

FIG. 2 is a view similar to FIG. 1, with a lamp cover being moved a distance from a lamp body of the LED lamp of FIG. 1.

FIG. 3 is a cross-sectional view showing an LED lamp in accordance with a second embodiment of the present disclosure.

FIG. 4 is a cross-sectional view showing an LED lamp in accordance with a third embodiment of the present disclosure.

FIG. 5 is a cross-sectional view showing an LED lamp in accordance with a fourth embodiment of the present disclosure.

FIG. 6 is a cross-sectional view showing an LED lamp in accordance with a fifth embodiment of the present disclosure.

FIG. 7 is a cross-sectional view showing an LED lamp in accordance with a sixth embodiment of the present disclosure.

FIG. 8 is a cross-sectional view showing an LED lamp in accordance with a seventh embodiment of the present disclosure.

### DETAILED DESCRIPTION

Embodiments of an LED lamp will now be described in detail below and with reference to the drawings.

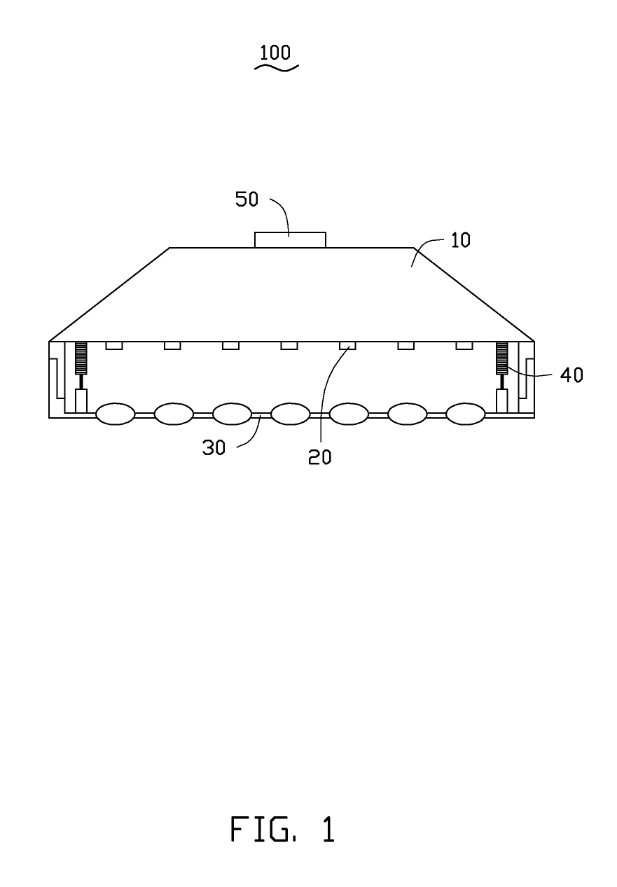

Referring to FIG. 1, an LED lamp 100 in accordance with a first embodiment is provided. The LED lamp 100 includes a lamp body 10, a plurality of light emitting diodes 20 formed on the lamp body 10, a lamp cover 30 to cover the light emitting diodes 20, two drivers 40 formed between the lamp body 10 and the lamp cover 30 and located at two opposite lateral sides of the LED lamp 100, and an adjusting device 50.

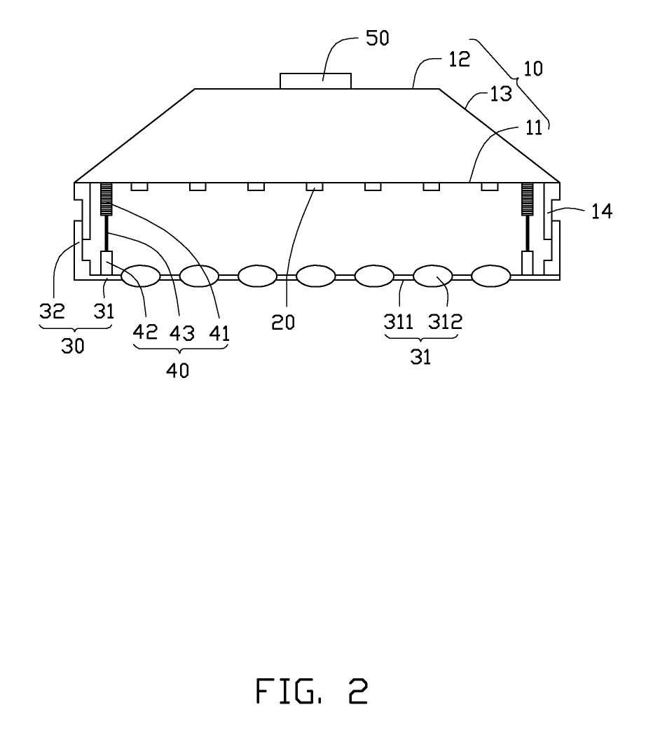

Referring to FIG. 2, the lamp body 10 includes a substrate 11, a rear plate 12 opposite to the substrate 11 and a side plate 13 surrounding and interconnecting the substrate 11 and the rear plate 12. In this embodiment, an area of the substrate 11 is greater than that of the rear plate 12. The substrate 11 faces to the lamp cover 30. The substrate 11 is made of thermally conductive and electrically insulating materials, such as ceramic. Alternatively, the substrate 11 can be made of epoxy resin, silicone or polyphthalamide (PPA). The substrate 11 has electrodes (not shown) to electrically connect with the light emitting diodes 20. The adjusting device 50 is formed on the rear plate 12 and electrically connected with the drivers 40 to provide power to the drivers 40. The side plate 13 surrounds the substrate 11 and the rear plate 12. A first flange 14 is formed around the substrate 11. The first flange 14 is annular and extends downwardly from the side plate 13 toward the lamp cover 30.

The light emitting diodes 20 are arranged on the substrate 11 with a same interval. The light emitting diodes 20 are mounted on the substrate 11 in a flip-chip method; therefore, electrodes of the light emitting diodes 20 are electrically connected with the electrodes on the substrate 11. In this embodiment, the light emitting diodes 20 are arranged in a matrix.

The lamp cover 30 includes a cover plate 31 and a second flange 32 formed on a periphery of the cover plate 31. The cover plate 31 is in front of the light emitting diodes 20. In this embodiment, the cover plate 31 and the second flange 32 are integrally formed as a single monolithic material. In an alternative embodiment, the cover plate 31 and the second flange 32 can be formed respectively and assembled together. The second flange 32 is annular and faces to the first flange 14. An inner diameter of the second flange 32 is equal to an outer diameter of the first flange 14 to make the second flange 32 to sleeve on the first flange 14. A lube can be applied between the first flange 14 and second flange 32 to smoothen the relative movement therebetween.

The cover plate 31 includes a supporting member 311 and a plurality of lenses 312 formed on the supporting member 311. The lens 312 is made of transparent materials, such as glass and resin. The lens 312 can be integrally formed with the supporting member 311. In an alternative embodiment, the lens 312 and the supporting member 311 can be formed respectively and assembled together. The lens 312 is convex and has a thickness gradually decreased from a center portion to a periphery thereof. The lenses 312 are arranged on the supporting member 311 in a matrix. Each lens 312 faces a corresponding light emitting diode 20, whereby light from the corresponding light emitting diode 20 is modulated by the lens 312 to have a desired light pattern.

The two drivers 40 are formed on the two opposite lateral sides of the LED lamp 100, by which a space is defined between the lamp body 10 and the lamp cover 30. Each driver 40 includes a stepping motor 41, a sleeve 42 and a shaft 43 formed between the stepping motor 41 and the sleeve 42. The stepping motor 41 is fixed to the substrate 11 of the lamp body 10, and the shaft 43 is fixed to the cover plate 31 of the lamp cover 30. The stepping motor 41 drives the shaft 43 to rotate, thereby making the shaft 43 to screw in or screw out of the sleeve 42. For example, an outer thread is formed on an outer surface of the shaft 43, and an inner thread is formed on an inner surface of the sleeve 42. When the shaft 43 rotates by the stepping motor 41, the shaft 43 can screw in or screw out of the sleeve 42.

When the LED lamp 100 is in operation, light from the light emitting diode 20 passes through the lens 312 in the lamp cover 30 to generate a predetermined lighting distribution. To meet the different requirements of the outer environment, the lighting distribution of the LED lamp 100 can be adjusted by the adjusting device 50. Referring to FIG. 2, the adjusting device 50 provides power for the stepping motors 41 of the drivers 40. The rotation of the stepping motors 41 drives the shafts 43 to screw in or screw out of the sleeves 42 to adjust a distance between the lamp body 10 and the lamp cover 30. Therefore, a distance between the light emitting diodes 20 and the lamp cover 30 can be adjusted. The change of the distance between the light emitting diodes 20 and the lamp cover 30 will cause the change of the lighting distribution (i.e., light field) of the LED lamp 100.

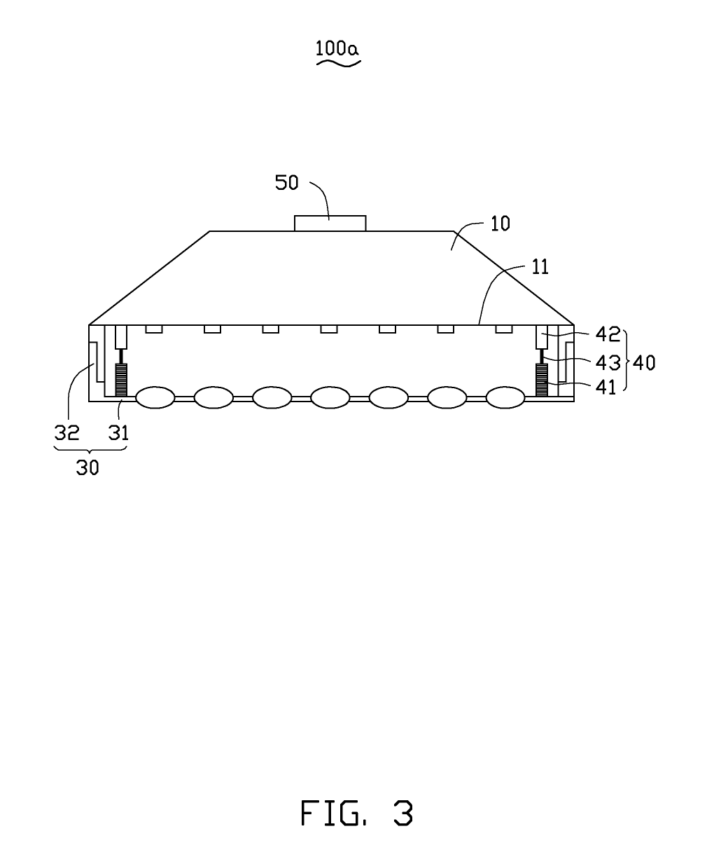

Referring to FIG. 3, an LED lamp 100a according to a second embodiment is provided. Different from the first embodiment, the stepping motors 41 of the drivers 40a are fixed to the cover plate 31 of the lamp cover 30, and the sleeves 42 of the drivers 40a are fixed to the substrate 11 of the lamp body 10.

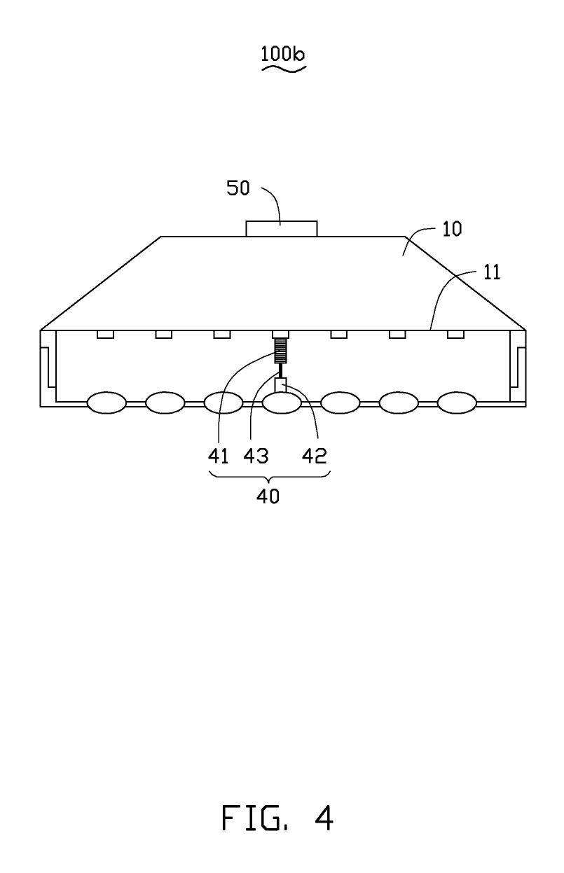

Referring to FIG. 4, an LED lamp 100b according to a third embodiment is provided. Different from the first embodiment, the LED lamp 100b includes a driver 10. The driver 10 is formed at a center of the LED lamp 100b and interconnecting centers of the lamp body 10 and the lamp cover 30. The stepping motor 41 of the driver 10 is fixed to the center of the substrate 11 of the lamp body 10. The sleeve 42 is fixed to the center of the cover plate 31 of the lamp cover 30.

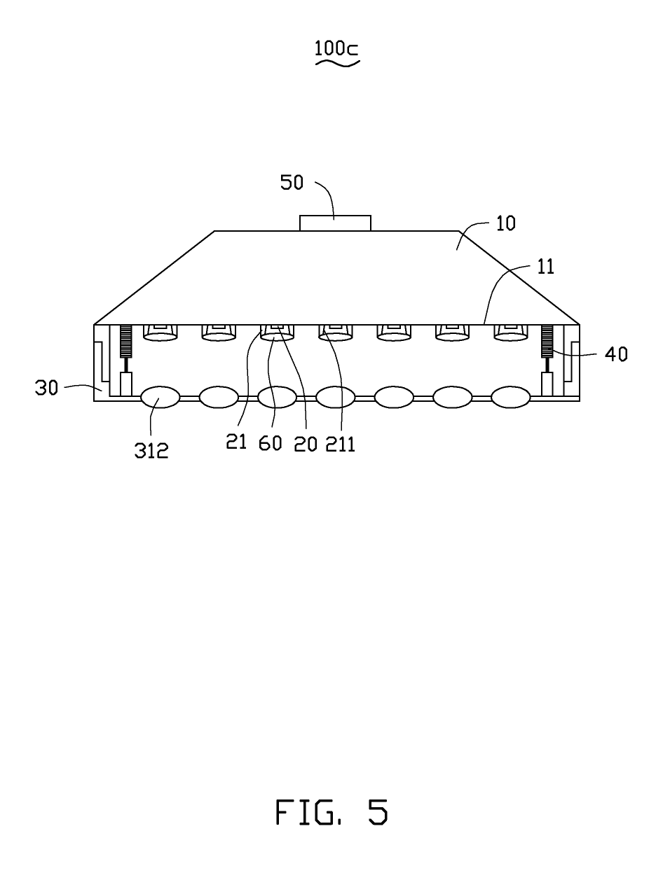

Referring to FIG. 5, an LED lamp 100c according to a fourth embodiment is provided. The LED lamp 100c further includes a reflector cup 21 formed around the light emitting diode 20. A package lens 60 is formed at a position in front of the light emitting diode 20. A diameter of the reflector cup 21 gradually increases from the substrate 11 of the lamp body 10 to the package lens 60. The reflector cup 21 has an inner reflecting surface 211 facing to the light emitting diode 20. The inner reflecting surface 211 is inclined. The package lens 60 is convex and proceeds with a primary light modulation for light from the light emitting diode 20. The lens 312 of the lamp cover 30 proceeds with a secondary light modulation for the light emitted from the light emitting diode 20 and passing through the package lens 60.

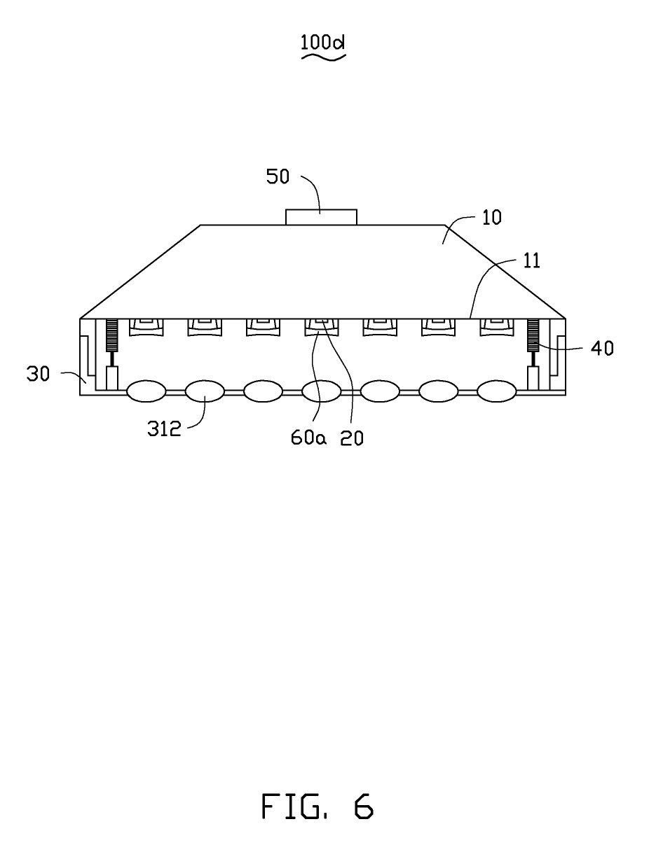

Referring to FIG. 6, an LED lamp 100d according to a fifth embodiment is provided. The LED lamp 100d is similar to the LED lamp 100c. Different from the LED lamp 100c, the package lens 60a on the light emitting diode 20 of the LED lamp 100d is concave. The concave package lens 60a and the convex lens 312 cooperatively form a lighting distribution different from that achievable by the LED lamp 100c of FIG. 5.

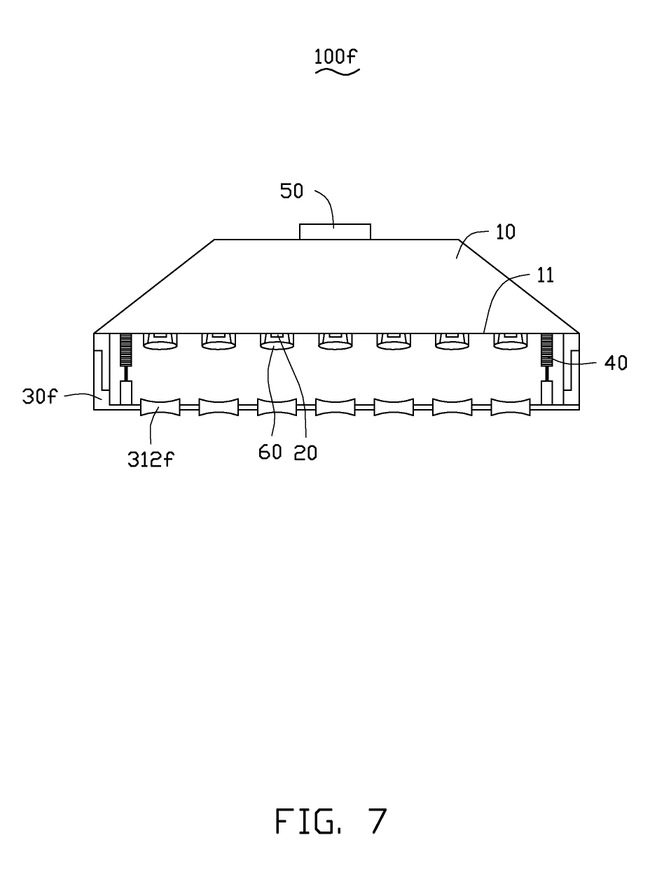

Referring to FIG. 7, an LED lamp 100f according to a sixth embodiment is provided. In this embodiment, each lens 312f of the lamp cover 30f in the LED lamp 100f is concave.

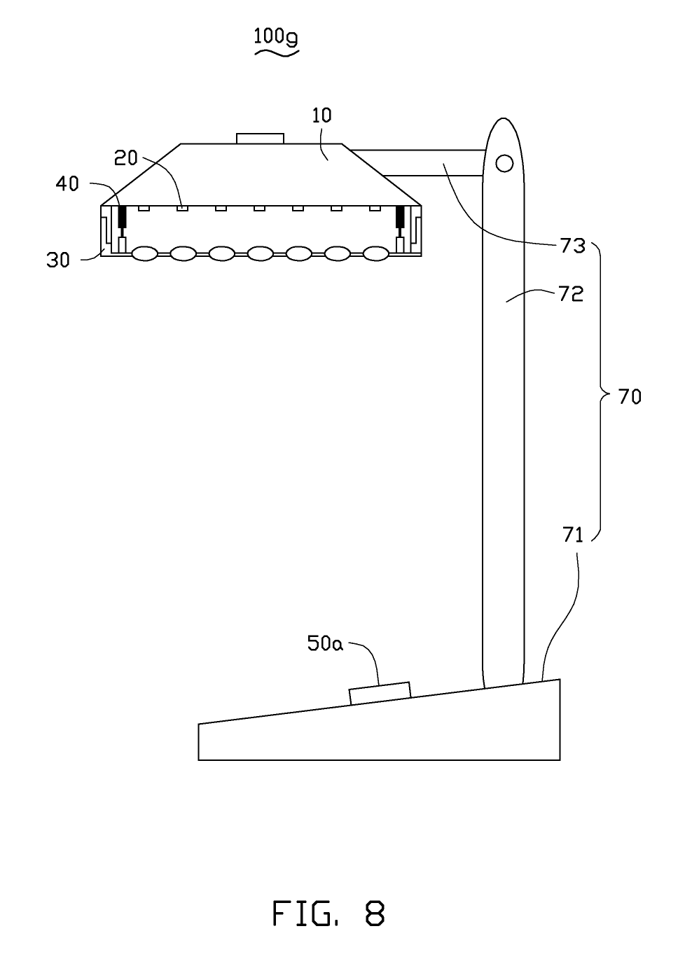

Referring to FIG. 8, an LED lamp 100g according to a seventh embodiment is provided. In this embodiment, the LED lamp 100g further includes a lamp support 70. The lamp support 70 includes a base 71, a pole 72 extended upwardly from the base 71 and a supporting bar 73. The lamp body 10 of the LED lamp 100g is secured to a free end of the supporting bar 73 which in turn is pivotally connected with the pole 72. An adjusting device 50a of the LED lamp 100g is secured to the base 71. The supporting bar 73 is rotatable around the pole 72 to adjust a position of the lamp body 10. The LED lamp 100g can be used as a table lamp or a street lamp. The adjusting device 50 is used for driving the drivers 40 to operate, thereby adjusting the distance between the lamp body 10 and the lamp cover 30.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A light emitting diode lamp, comprising:
a lamp body;
a light emitting diode arranged on the lamp body;
a lamp cover to cover the light emitting diode, the lamp cover comprising a lens in front of the light emitting diode, light from the light emitting diode being modulated by the lens;
a driver; and
an adjusting device, which controls the driver to adjust a distance between the lens and the light emitting diode.

2. The light emitting diode lamp of claim 1, wherein the lens is convex.

3. The light emitting diode lamp of claim 1, wherein the lens is concave.

4. The light emitting diode lamp of claim 1, wherein the driver is formed between the lamp cover and the lamp body.

5. The light emitting diode lamp of claim 4, wherein the driver comprises a stepping motor, a sleeve and a shaft rotatable with the stepping motor and threadedly engaging in the sleeve.

6. The light emitting diode lamp of claim 5, wherein the shaft comprises an outer thread on an outer surface thereof, and the sleeve comprises an inner thread on an inner surface thereof, the stepping motor rotates the shaft to screw in or screw out of the sleeve.

7. The light emitting diode lamp of claim 6, wherein the stepping motor is fixed to the lamp body, and the sleeve is fixed to the lamp cover.

8. The light emitting diode lamp of claim 6, wherein the stepping motor is fixed to the lamp cover, and the sleeve is fixed to the lamp body.

9. The light emitting diode lamp of claim 1, wherein the lamp body comprises a first flange extended to the lamp cover, the lamp cover comprises a second flange extended to the lamp body, the second flange is sleeved on the first flange.

10. The light emitting diode lamp of claim 9, wherein the lamp body comprises a substrate, a rear plate opposite to the substrate, and a side plate surrounds and interconnects the substrate and the rear plate, the substrate faces to the lamp cover, the first flange extends from the side plate to the lamp cover.

11. The light emitting diode lamp of claim 10, wherein the substrate is made of a material selected from a group consisting of ceramic, epoxy resin, silicone and polyphthalamide.

12. The light emitting diode lamp of claim 9, wherein the lamp cover comprises a cover plate facing the light emitting diode, the second flange extends from a periphery of the cover plate to the lamp body, the cover plate further comprises a supporting plate, and the lens is arranged on the supporting plate.

13. The light emitting diode lamp of claim 1, wherein a reflector cup is formed around the light emitting diode, a package lend is formed on the reflector cup, the reflector cup has an inner diameter gradually increasing from the lamp body to the package lens, thereby forming an inclined reflective surface facing the light emitting diode.

14. The light emitting diode lamp of claim 13, wherein the package lens is convex.

15. The light emitting diode lamp of claim 13, wherein the package lens is concave.

16. The light emitting diode lamp of claim 1, further comprising a lamp support, the lamp support comprising a base, a pole extending upwardly from the base and a supporting bar pivotally connected with the pole, the lamp body being secured to a free end of the supporting bar.
